(19) United States
(12) Patent Application Publication
(10) Pub. No.: US 2010/0040841 A1
(43) Pub. Date: Feb. 18, 2010

(54) WEB-LIKE COATING FILM

(75) Inventor: Heinz Haller, Plochingen (DE)

Correspondence Address: BACHMAN & LAPOINTE, P.C., 900 CHAPEL STREET, SUITE 1201, NEW HAVEN, CT, 06510, US

(73) Assignee: KUNZ-HOLDING GMBH & CO. KG, Unterensingen (DE)

(21) Appl. No.: 11/813,962

(22) PCT Filed: Nov. 29, 2005
(86) PCT No.: PCT/EP05/12709

§ 371 Date: Jul. 13, 2007

(30) Foreign Application Priority Data
Jan. 13, 2005 (DE) 20 2005 000 556.8

(51) Int. Cl. D21H 27/28; B32B 27/10; B32B 5/02; D21H 27/26; B44C 5/04

(52) U.S. Cl. 428/200; 428/211.1; 428/208

(57) ABSTRACT

A web-like, decorative coating film which is designed to be applied to a support, in particular a floor, door or furniture outer surface, and is in a state which is or can be rolled up, includes a decoratively printed support layer (10) made of paper and/or plastic and a dried base layer (12) which contains a radiation-curing resin but preferably no thermocuring resin in the uncrosslinked state and also an abrasive, preferably inorganic filler, said base layer being formed on the support layer from an aqueous application.

The present invention relates to a web-like coating film which is designed to be applied to a support, for example a floor, door or furniture outer surface, and which is suitable for being lacquered with a radiation-curing lacquer to produce a scratch-resistant surface coating.

Decorative coating films, for example in the form of so-called finish films, are known in general from the prior art; they are used for example for the manufacture of furniture and, as an exception, for the manufacture of laminate floors.

Particularly in this field of use or for coating other surfaces which are subject to considerable stress, such as for example in the kitchen or industrial production sector, one important factor is the abrasion resistance of a coating produced with a coating film. Procedures in which corundum-containing, thermosetting resins are used for laminate floors are known from the prior art; the corundum is either contained in a paper support (otherwise free of fillers) which is then impregnated with melamine-formaldehyde resin, or else suitable papers are impregnated with corundum-containing resins (see in this respect for example DE 195 08 797 C1). Once the resin films together with an underlying paper which has also been impregnated with resin (and is typically printed) has been pressed onto a support panel, a decorative material with an abrasion-resistant, thermosetting coating is obtained.

An alternative procedure for producing abrasion-resistant coatings is disclosed in DE 42 19 446. Fillers (usually corundum) are incorporated in radiation-curing binders, with the binders then being applied in liquid form to a support. After crosslinking by irradiation with UV or electron beams, the corundum particles are firmly incorporated in the crosslinked binder, so that the desired coating with high abrasion resistance is obtained.

However, the two procedures from the prior art described above are suitable only to a limited extent and under certain conditions for producing film-like coatings which can be laminated and coated at will (i.e. are highly flexible). This is because coatings containing thermosetting and radiation-crosslinking binders are very brittle, particularly in the case of relatively large layer thicknesses and a high crosslinking density. Moreover, the coatings produced in the manner described above, when they are in film form, are not flat but rather tend undesirably to roll up considerably (become dish-shaped), so that subsequent further processing is made much more difficult.

The object of the present invention is therefore to provide a decorative coating film as starting material (semifinished product) for a subsequent lacquering or coating process with a topcoat, wherein a coating thus produced should have excellent properties with regard to abrasion resistance.

This object is achieved by the coating film having the features of the main claim; advantageous further developments of the invention are described in the dependent claims.

Advantageously according to the invention, use is made of a compound which is applied in aqueous form and is used for the base layer, said compound containing resins which cure under the effect of radiation (radiation-curing resins) (within the context of the invention, “radiation-curing” is understood to mean a resin which can be crosslinked and cured by means of electron beams or by irradiation with UV light, wherein photoinitiators may optionally be added thereto), dry physically but do not cure thermally.

Such a binder system as a base layer in the context of the present invention advantageously ensures on the one hand that the fillers (e.g. corundum) which bring about the abrasion resistance can be held with a high binding effect, but at the same time such a coating is also suitable for the extremely adhesive application of a topcoat (topcoat lacquer), wherein a radiation crosslinking through two layers (base layer and additional topcoat) which is thereby made possible ensures good adhesion. Furthermore, the topcoat lacquer that is advantageously also to be used ensures that the corundum layer is completely covered.

Finally, the base layer used according to the invention is characterized by a high degree of transparency, so that the decorative pattern (e.g. a printed pattern) formed on the underlying support layer made of paper or plastic remains visible with a high image quality after the coating is finished.

Within the scope of one preferred further development of the invention, (medium to coarse) inorganic fillers, in particular corundum particles having a particle size of 5 to 70 μm, are used to provide the prerequisite for a subsequent, high-quality, abrasion-resistant layer arrangement in conjunction with a suitable topcoat.

By virtue of the present invention, the base material (semifinished product) for a coating is advantageously achieved, which is favorably suitable for further production steps. Not only does it have considerably increased flexibility properties (compared to the products known from the prior art) (so that even problematic lamination tasks, such as the coating of profile strips or parts of furniture for example, can be carried out easily and without breaks or tears), the product according to the invention is also extremely flat and does not tend to roll inwards or to roll up in a disadvantageous manner. Not least for this reason, it is also possible according to one further development to provide the coating film according to the invention (prior to an application of a topcoat according to one further development) with a suitable sealing layer or hot-melt adhesive layer on the rear side, so that it can then be applied easily to a desired lamination support (e.g. a wood panel to be coated), for example by means of hot-pressing or the like.

Since, compared to abrasion-resistant surfaces known from the prior art, a coating based on the present invention either considerably improves the abrasion properties or else products with comparable abrasion properties would have a much larger layer thickness (along with the associated disadvantages of brittleness and lack of suitability for coatings requiring flexibility), it is to be expected that the abrasion-resistant coating according to the present invention will open up completely new fields of use and application. In this connection, it will then be ascertained that, not least on account of the savings in terms of material due to the relatively thin layers, a reduction in production costs of around 20% is possible.

Further advantages, features and details of the invention will emerge from the following description of preferred examples of embodiments and with reference to the single drawing, in which:

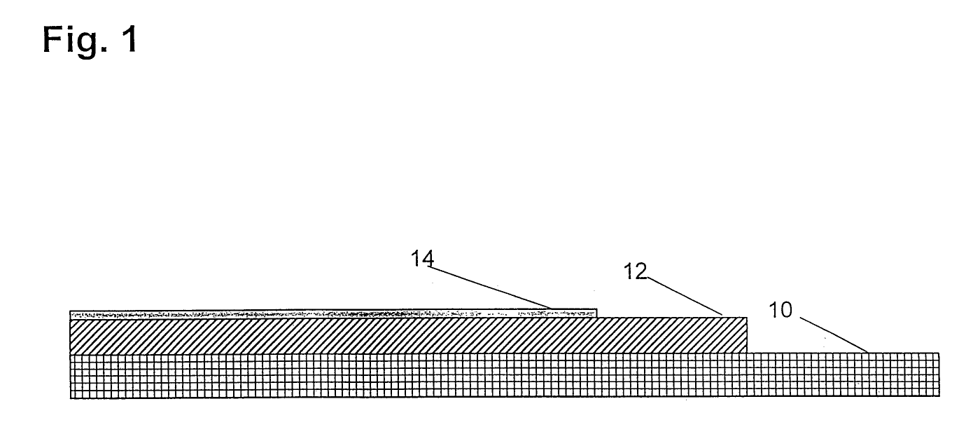

FIG. 1 shows the schematic layer structure of the decorative coating film according to a first preferred embodiment of the present invention, with a topcoat additionally applied after a lamination process (not shown).

The web-like support shown in FIG. 1 comprises as the support layer 10 a layer of printed paper having a thickness of typically 35 to 90 micrometers. The printed pattern is applied directly to the paper layer 10. A base layer 12 is formed thereon. While the base layer 12 is formulated to achieve a maximum abrasion resistance and contains abrasive inorganic fillers (in particular Al₂O₃ and SiO₂), a topcoat that is to be subsequently applied (in particular after the arrangement consisting of support layer and base layer has been laminated onto a suitable surface) serves inter alia to seal the base layer and determines the further surface properties, in particular the glossiness, haptics and surface structure.

The base layer, applied with otherwise known coating aggregates as a roller application by means of a slotted nozzle or doctor blade in a typical layer thickness between approximately 10 and 100 micrometers, contains aqueous radiation-curing resins between 22% and 95% (in the example: 40%) and also inorganic fillers in the form of the abovementioned abrasive substances and additionally color pigments (e.g. TiO₂) in a possible range between 10% and 70%, in the example of embodiment approximately 60%.

A typical recipe for producing the coating material for the base layer 12 could be implemented for example as follows:

60 parts aqueous radiation-curing resin (IRR 395, 40%)

40 parts filler (Plakor 30).

To implement the invention as a semifinished product, the dried arrangement (but without the topcoat shown in FIG. 1) and in the uncrosslinked state of the base layer 12 would then be rolled up in a suitable manner and thus made available for further processing, for example lamination followed by application of a topcoat.

During further processing of the product produced according to the invention, the topcoat may then consist of a radiation-curing binder, which may be completely solvent-free, or of a radiation-curing, aqueous dispersion. Suitable resins for the topcoat include polyester acrylates, epoxy acrylates or urethane acrylates, wherein these may be modified in terms of their molecular structure by so-called nanoparticles in order to improve the scratch resistance.

A typical radiation-curing resin product for producing the topcoat is e.g. Ebecryl 1016. Application once again takes place by means of known coating possibilities, for example application by means of a roller, a slotted nozzle or a doctor blade, wherein application takes place after a lamination process, in a separate step, offline and in particular in a separate coating installation. The subsequent curing of the topcoat by means of irradiation (UV or electron beams) additionally brings about the curing of the radiation-curing components of the base layer, wherein, in the case of curing by means of UV radiation, suitable photoinitiators are added to the radiation-curing components.

The film arrangement thus produced which is based on the coating film according to the invention as a semifinished product is characterized by a very high abrasion resistance of more than 1500 revolutions, usually more than 2500 revolutions (method S42 according to standard EN 13329).

1. A web-like, decorative coating film which is designed to be applied to a support, in particular a floor, door or furniture outer surface, and is in a state which is or can be rolled up, comprising
a decoratively printed support layer (10) made of paper and/or plastic and
a dried base layer (12) which contains a radiation-curing resin in the uncrosslinked state and also an abrasive, said base layer being formed on the support layer from an aqueous application.

2. A coating film according to claim 1, characterized in that the base layer (12) applied in liquid or pasty form has been applied aqueously in a layer thickness between 10 and 100 μm and/or has been applied in such a layer thickness that the base layer in the dried state has a thickness between 20 and 70 μm.

3. A coating film according to claim 1, characterized in that the radiation-curing resins of the base layer are an aqueous mixture of high molecular weight and low molecular weight prepolymers.

4. A coating film according to claim 1, characterized in that the support layer is a dry web which has been selected from the group consisting of preimpregnated paper with thermal or radiation-crosslinking binders, plastic film, wood veneer, fibrous material web and/or flexible panel substrate.

5. A coating film according to claim 1, characterized in that the base layer is dried in such a way that the base layer joined to the support layer has a residual moisture content of less than 1% and/or the support layer coated with the base layer is non-tacky and can be wound.

6. A coating film according to claim 1, characterized by a thermally reactive adhesive on the side of the support layer opposite the base layer, wherein the adhesive has an application weight in the range between 10 and 20 g/m², and/or the adhesive has a reaction temperature<160° C.

7. A coating film according to claim 1, characterized in that the base layer is designed to be lacquered with a radiation-curing lacquer which can be crosslinked together with the base layer by means of ionizing radiation.

8. A coating film according to claim 7, characterized in that photoinitiators are added to the base layer.

9. A coating film according to claim 1, characterized in that the abrasive comprises corundum and/or ground quartz.

10. A coating film according to claim 1, characterized in that the coating film is designed to be laminated onto wood and/or plastic materials in panel form.

11. A coating film according to claim 1, characterized in that the coating film is designed for the manufacture of floors, worktops, doors, window sills, furniture, kitchen surfaces or surfaces of industrial or laboratory environments.

12. A coating film according to claim 1, wherein the dried base layer contains no thermocuring resin, and wherein the abrasive is an inorganic filler.

13. A coating film according to claim 1, wherein particle size of the abrasive is adapted to a layer thickness of the base layer.

14. A coating film according to one of claims 1, wherein the adhesive has an application weight in the range between 15 to 20 g/m², and/or the adhesive has a reaction temperature<100° C.

15. A coating film according to claim 7, wherein the radiation-curing lacquer comprises a UV or electron-beam-curing lacquer.

16. A coating film according to claim 9, wherein the abrasive has a particle size in the range between 5 μm and 70 μm mean particle size.

17. A coating film according to claim 1, wherein the coating film is designed for manufacture of flexible floor elements.
